(19) United States
(12) Patent Application Publication
(10) Pub. No.: US 2025/0378487 A1
(43) Pub. Date: Dec. 11, 2025

(54) METHODS AND SYSTEMS FOR AUGMENTED REALITY ASSISTED AUTOMOTIVE INSPECTION AND AUTOMATIC ORDERING OF AUTOMOTIVE PARTS AND/OR SERVICES

(71) Applicant: BABU VINOD, palo alto, CA (US)

(72) Inventor: BABU VINOD, palo alto, CA (US)

(21) Appl. No.: 19/096,544

(22) Filed: Mar. 31, 2025

Related U.S. Application Data
(63) Continuation-in-part of application No. 18/788,093, filed on Jul. 29, 2024, now abandoned.
(60) Provisional application No. 63/529,718, filed on Jul. 29, 2023.
(60) Provisional application No. 63/529,720, filed on Jul. 29, 2023.
(60) Provisional application No. 63/529,721, filed on Jul. 29, 2023.
(60) Provisional application No. 63/529,719, filed on Jul. 29, 2023.

(51) Int. Cl. G06Q 30/0601; G06F 3/01; G06T 11/00; G06V 20/20

(52) U.S. Cl. CPC G06Q 30/06443; G06F 3/017; G06Q 30/0633; G06T 11/00; G06V 20/20; G06V 2201/08

(57) ABSTRACT

A method for augmented reality assisted automotive inspection and automatic ordering of automotive parts and/or services begins with the detection of an automobile inspection session's initiation using an AR headset worn by a technician. The system then generates relevant AR elements for the inspection session, which may include technician workflows, part identifications, part descriptions, and ranked ordering options for parts and services. These AR elements are displayed as an overlay to the technician's field of view through the AR headset. The method includes detection of a technician's selection of a part or service via voice command, gesture recognition, or gaze tracking. Finally, the selected part or service is automatically ordered without requiring any physical manual input from the technician, streamlining the entire inspection and ordering process.

### CLAIM OF PRIORITY

This application is a continuation in part of U.S. patent application Ser. No. 18/788,093, filed Jul. 29, 2024, and titled METHODS AND SYSTEMS FOR AUGMENTED REALITY ASSISTED AUTOMOTIVE INSPECTION AND AUTOMATIC ORDERING OF AUTOMOTIVE PARTS AND/OR SERVICES. This utility application is hereby incorporated by reference in its entirety.

U.S. patent application Ser. No. 18/788,093 claims priority to U.S. Provisional Patent Application No. 63/529,718, filed on Jul. 29, 2023, and titled METHODS AND SYSTEMS FOR AUTOMATED SCHEMA MERGERS. This provisional patent application is hereby incorporated by reference in its entirety.

U.S. patent application Ser. No. 18/788,093 claims priority to U.S. Provisional Patent Application No. 63/529,720, filed on Jul. 29, 2023, and titled METHODS AND SYSTEMS FOR AUGMENTED REALITY ASSISTED AUTOMOTIVE INSPECTION AND AUTOMATIC ORDERING OF AUTOMOTIVE PARTS AND/OR SERVICES. This provisional patent application is hereby incorporated by reference in its entirety.

U.S. patent application Ser. No. 18/788,093 claims priority to U.S. Provisional Patent Application No. 63/529,721, filed on Jul. 29, 2023, and titled METHODS AND SYSTEMS FOR AUGMENTED REALITY ASSISTED AUTOMOTIVE INSPECTION AND INTEGRATION OF EXPERT REVIEW AND ASSISTANCE. This provisional patent application is hereby incorporated by reference in its entirety.

U.S. patent application Ser. No. 18/788,093 claims priority to U.S. Provisional Patent Application No. 63/529,719, filed on Jul. 29, 2023, and titled METHODS AND SYSTEMS FOR AUTOMATED PROJECT PLANNING WITH GENERATIVE AI. This provisional patent application is hereby incorporated by reference in its entirety.

### BACKGROUND OF THE INVENTION

### Field of the Invention

The present invention relates generally to automotive repair and maintenance systems, and more particularly to augmented reality systems for facilitating automotive inspection processes and parts ordering.

### Description of the Related Art

Automotive inspection and repair processes have traditionally been labor-intensive and time-consuming tasks requiring significant manual intervention. Technicians typically follow paper-based or digital checklists while physically documenting their findings, manually referencing technical manuals, and ordering replacement parts through separate computer systems or phone calls. This workflow creates several inefficiencies, including:

Technicians must frequently switch between inspection tasks and documentation activities, leading to workflow interruptions and potential errors in recording findings.

Parts identification and ordering commonly require technicians to step away from the vehicle to access separate computer systems, catalogs, or parts counters, extending the overall service time.

Less experienced technicians often require assistance from senior staff to properly identify parts and follow correct inspection procedures, creating bottlenecks in service operations.

Manual data entry for parts ordering introduces opportunities for errors in part numbers, specifications, or quantities.

Conventional digital solutions have attempted to address these challenges through tablet-based applications or computer workstations in service bays. However, these approaches still require technicians to divide their attention between the vehicle and digital devices, necessitating physical interaction with screens or keyboards while performing inspections.

Additionally, existing solutions typically maintain separation between inspection workflows, technical documentation, and parts ordering systems, requiring technicians to navigate multiple interfaces and often re-enter information across different platforms.

Previous attempts to incorporate advanced technologies such as computer vision for part identification or voice commands for system interaction have generally been limited to narrow applications rather than comprehensive workflow solutions. These piecemeal approaches fail to provide the seamless integration necessary for significant efficiency improvements in the inspection-to-ordering process.

Accordingly, there remains a need for improved systems and methods that can streamline the automotive inspection process, reduce manual documentation requirements, eliminate workflow interruptions, and automate parts ordering while allowing technicians to maintain focus on the vehicle being serviced.

### SUMMARY OF THE INVENTION

In one aspect, a method for augmented reality assisted automotive inspection and automatic ordering of automotive parts and/or services begins with the detection of an automobile inspection session's initiation using an AR headset worn by a technician. The system then generates relevant AR elements for the inspection session, which may include technician workflows, part identifications, part descriptions, and ranked ordering options for parts and services. These AR elements are displayed as an overlay to the technician's field of view through the AR headset. The method includes detection of a technician's selection of a part or service via voice command, gesture recognition, or gaze tracking. Finally, the selected part or service is automatically ordered without requiring any physical manual input from the technician, streamlining the entire inspection and ordering process.

### BRIEF DESCRIPTION OF THE DRAWINGS

FIG. 1 illustrates an example process used for augmented reality assisted automotive inspection and automatic ordering of automotive parts and/or services, according to some embodiments.

FIG. 2 illustrates an example AI automotive inspection assistant system, according to some embodiments.

FIG. 3 is a block diagram of a sample computing environment that can be utilized to implement various embodiments.

FIG. 4 illustrates an AR view of what a technician would see through the AR headset during an automotive inspection workflow, according to some embodiments.

FIG. 5 shows an example view of AR menu interfaces overlaid on the engine compartment, according to some embodiments.

FIG. 6 illustrates an example process for augmented reality assisted automotive inspection and automatic ordering of automotive parts and/or services, according to some embodiments.

FIG. 7 shows a view of the AR interface during an active inspection session with an “UPDATE REPAIR ORDER” header visible at the top, according to some embodiments.

FIG. 8 illustrates a view of the vehicle identification and customer information capabilities of the system.

FIG. 9 illustrates a view of the AR menu interface with inspection task tracking and status indicators, according to some embodiments.

FIG. 10 provides a view that demonstrates the parts recommendation feature with a “PARTS RECOMM” label, according to some embodiments.

FIG. 11 illustrates a view that shows the system's main menu interface, according to some embodiments.

The Figures described above are a representative set and are not an exhaustive with respect to embodying the invention.

### DESCRIPTION

Disclosed are a system, method, and article of manufacture for augmented reality assisted automotive inspection and automatic ordering of automotive parts and/or services. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Automotive aftermarket is the secondary parts market of the automotive industry, concerned with the manufacturing, remanufacturing, distribution, retailing, and installation of all vehicle parts, chemicals, equipment, and accessories, after the sale of the automobile by the original equipment manufacturer (OEM) to the consumer. The parts, accessories, etc. for sale may or may not be manufactured by the OEM. The aftermarket encompasses parts for replacement, collision, appearance, and performance. The aftermarket provides a wide variety of parts of varying qualities and prices for nearly all vehicle makes and models.

Application program is a computer program designed to carry out a specific task other than one relating to the operation of the computer itself, typically to be used by end-users.

App (application) store (e.g. an app marketplace) is a type of digital distribution platform for computer software called applications, often in a mobile context. Apps provide a specific set of functions which, by definition, do not include the running of the computer itself. Complex software designed for use on a personal computer, for example, may have a related app designed for use on a mobile device. Apps can be normally designed to run on a specific operating system—such as the contemporary iOS, macOS, Windows or Android—but in the past mobile carriers had their own portals for apps and related media content.

Generative Pre-trained Transformer 4 (GPT-4) is a multimodal large language model created by OpenAI, and the fourth in its numbered “GPT-n” series of GPT foundation models. As a transformer-based model, GPT-4 was pretrained to predict the next token (e.g. using both public data and data licensed from third-party providers) and was then fine-tuned with reinforcement learning from human and AI feedback for human alignment and policy compliance. It is noted that other multimodal large language model can be utilized in other example embodiments.

Deep learning is part of a broader family of machine learning methods based on artificial neural networks with representation learning. Learning can be supervised, semi-supervised or unsupervised.

Deep neural network (DNN) is an artificial neural network (ANN) with multiple layers between the input and output layers. There are different types of neural networks, but they always consist of the same components: neurons, synapses, weights, biases, and functions.

Large language model (LLM) is a language model characterized by emergent properties enabled by its large size. An LLM can be built with artificial neural networks. These can be pre-trained. The training can utilize self-supervised learning and/or semi-supervised learning. For example, the artificial neural networks can contain tens of millions to billions of weights. The LLMs can be trained using a specialized AI accelerator hardware to parallel process vast amounts of text data, mostly scraped from the Internet. As language models, they work by taking an input text and repeatedly predicting the next token or word.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, logistic regression, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Natural language processing (NLP) is a branch of artificial intelligence concerned with automated interpretation and generation of human language. Natural language processing (NLP) is an interdisciplinary subfield of linguistics, computer science, and artificial intelligence concerned with the interactions between computers and human language, in particular how to program computers to process and analyze large amounts of natural language data. The goal is a computer capable of “understanding” the contents of documents, including the contextual nuances of the language within them. The technology can then accurately extract information and insights contained in the documents as well as categorize and organize the documents themselves. Challenges in natural language processing frequently involve speech recognition, natural-language understanding, and natural-language generation.

Optical character recognition or optical character reader (OCR) is the electronic or mechanical conversion of images of typed, handwritten, or printed text into machine-encoded text, whether from a scanned document, a photo of a document, a scene-photo and/or from subtitle text superimposed on an image.

These systems and functions can be incorporated into various embodiments discussed herein.

### Example Systems and Methods

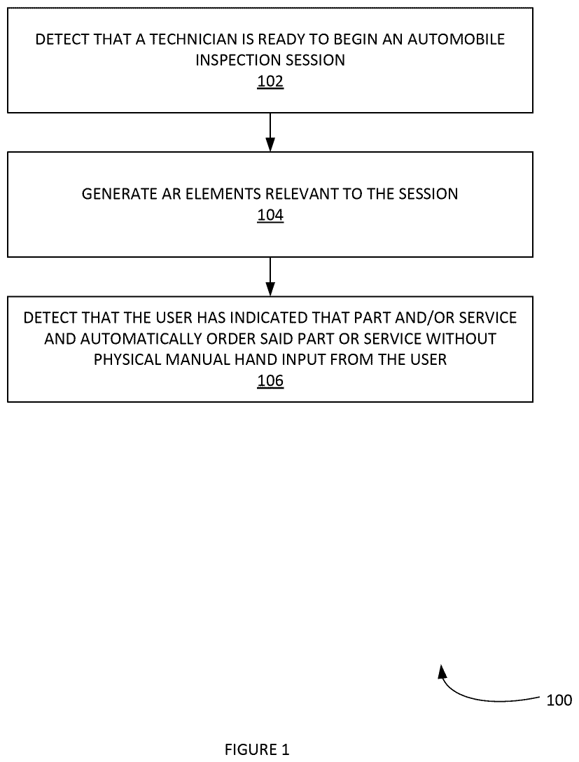

FIG. 1 illustrates an example process 100 used for an augmented reality assisted automotive inspection automatic ordering of automotive parts and/or services, according to some embodiments. In step 102, process 100 can detect that a technician is ready to begin an automobile inspection session. Process 100 can obtain the reason for the inspection, user preferences, etc. In step 104, process 100 can generate AR elements relevant to the session. These can include technician work flows, part identifications and/or descriptions, content that indicates parts and/or services can be automatically ordered in a ranked manner. In step 106, process 100 can detect that the user has indicated that part and/or service and automatically order said part or service without physical manual hand input from the user.

In one example, process 100 is completely hands free, guides through an n-point inspection. This can be a guided set of steps that are overlaid with what technician is viewing via an AR headset. The technician can request expert instruction experience to assist with an issue. This is provided to the AR headset and displayed thereon. The technician can order parts during inspection. A recommendation system can provide choices to the technician who can then select and send them to client for installation. Process 100 can automatically integrate recommendations of aftermarket parts with codes in a physical hand input manner (e.g. instead using explicit voice and/or AR-based user hand gesture, and/or an implicit manner). Process 100 automatically recognizes vehicle make and model and parts (also make and model, etc.).

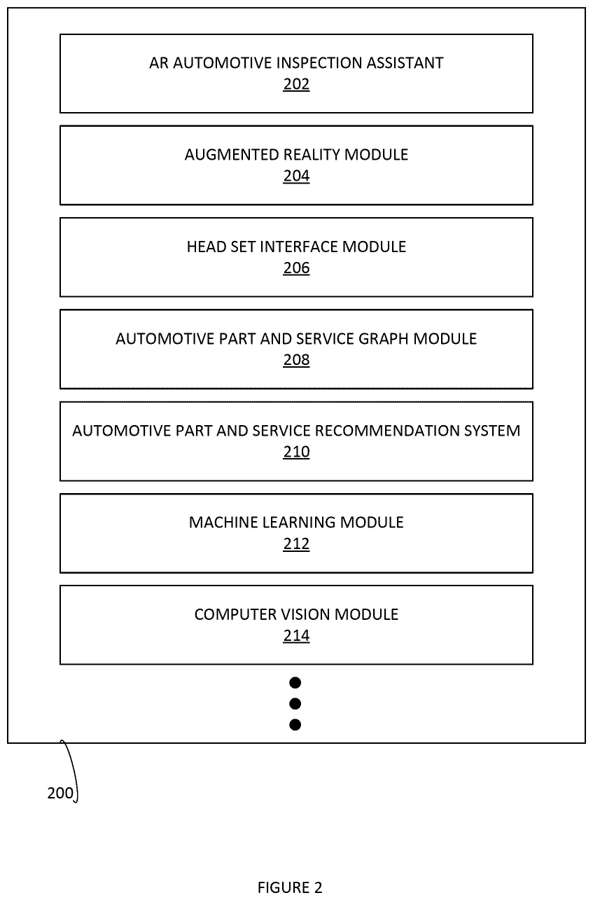

FIG. 2 illustrates an example AI automotive inspection assistant system 200, according to some embodiments. AI automotive inspection assistant system 200 can include an artificial intelligence assistant feature with various applications and services. These applications and services can include an AR automotive inspection assistant 202. AR automotive inspection assistant 202 can implement process 100. AI automotive inspection assistant 202 can obtain digital images/video content from AR Headset interface module 206. AR automotive inspection assistant 202 can cause AR images of automotive part identification in the AR Headset interface module 206. AR Headset interface module 206 uses AR indicators/content to guide a technician through a specific workflow. AR Headset interface module 206 can enable the technician to (in a hands-free mode) to obtain part/service recommendations and order said part/service recommendations. The part/service recommendations can be ranked according to various user indicated preferences (e.g. cost, quality, location of part, time of delivery, etc.). AI automotive inspection assistant system 200 can include additional systems and functionalities to optimize and support AI automotive inspection assistant 202.

Augmented reality module 204 can obtain information from the other elements of AI automotive inspection assistant system 200. Augmented reality module 204 can generate appropriate AR elements and populate said elements with the appropriate content (e.g. see APPENDIX A). The AR content can include, inter alia: the name(s) of the automotive parts in the user's field of view, the state of the automotive part(s), a sequence of actions for a technician to perform in a specific repair/inspection flow, available automotive part(s) that can be ordered for the user, etc. AR content can be obtained from various LLMs and automotive parts and service graph module 208.

Headset interface module 206 can interface with and/or include an AR headset system. Head set interface module 206 can include an outward-facing cameras, microphones, Wi-Fi systems, cellular data systems, etc.

Automotive part and service graph module 208 provide/utilize an API that evaluates the context and available Automotive part and service data before modifying and sending a prompt to the LLM. The prompt can be voice input by a technician and/or automatically inferred from the actions of the technician (e.g. based on a part the technician is touching/pointing to, etc.) and/or inferred from the AI headset field of view of the technician. After receiving the response from the LLM, Automotive part and service graph module 208 performs additional context-specific processing before sending it to AI automotive inspection assistant 202 to generate actual AR content to be utilized in the technician repair/inspection session. Automotive part and service graph module 208 can maintain a ranked graph of available aftermarket and/or OEM parts for all vehicles and/or services that technicians are interacting with.

Automotive part and service recommendation system 210 can obtain a list of available parts and/or services requested and/or implicitly detected by AI automotive inspection assistant 202. Automotive part and service recommendation system 210 can then rank and order the available parts and/or services.

Computer vision module 214 receives the digital images and/or videos of the AR headset and automatically determines the identity of objects therein. These can include auto parts, technician actions, and the like. Computer vision module 214 tasks include methods for acquiring, processing, analyzing and understanding digital images, and extraction of high-dimensional data from the real world in order to produce numerical or symbolic information, (e.g. in the forms of decisions, etc.). Understanding in this context means the transformation of visual images (e.g. the input to the retina in the human analog) into descriptions of the world that make sense to thought processes and can elicit appropriate action. This image understanding can be seen as the disentangling of symbolic information from image data using models constructed. Computer vision module 214 can also implement various functionalities, including, inter alia: object detection, event detection, video tracking, object recognition, 3D pose estimation, learning, indexing, motion estimation, visual servoing, 3D scene modeling, and image restoration.

Computer vision module 214 can implement the following operations. Image acquisition—A digital image is produced by one or several image sensors, which, besides various types of light-sensitive cameras, include range sensors, tomography devices, radar, ultra-sonic cameras, etc. Depending on the type of sensor, the resulting image data is an ordinary 2D image, a 3D volume, or an image sequence. The pixel values typically correspond to light intensity in one or several spectral bands (gray images or color images), but can also be related to various physical measures, such as depth, absorption or reflectance of sonic or electromagnetic waves, or nuclear magnetic resonance. Pre-processing—Before a computer vision method can be applied to image data in order to extract some specific piece of information, it is usually necessary to process the data in order to assure that it satisfies certain assumptions implied by the method. Examples are: Re-sampling to assure that the image coordinate system is correct. Noise reduction to assure that sensor noise does not introduce false information. Contrast enhancement to assure that relevant information can be detected. Scale space representation to enhance image structures at locally appropriate scales. Feature extraction—Image features at various levels of complexity are extracted from the image data.[25] Typical examples of such features are: Lines, edges and ridges. Localized interest points such as corners, blobs or points. More complex features may be related to texture, shape or motion. Detection/segmentation—At some point in the processing a decision is made about which image points or regions of the image are relevant for further processing. Examples are: Selection of a specific set of interest points. Segmentation of one or multiple image regions that contain a specific object of interest. Segmentation of image into nested scene architecture comprising foreground, object groups, single objects or salient object parts (also referred to as spatial-taxon scene hierarchy), while the visual salience is often implemented as spatial and temporal attention. Segmentation or co-segmentation of one or multiple videos into a series of per-frame foreground masks, while maintaining its temporal semantic continuity. High-level processing—At this step, the input is typically a small set of data, for example a set of points or an image region which is assumed to contain a specific object. The remaining processing deals with, for example: Verification that the data satisfy model-based and application-specific assumptions. Estimation of application-specific parameters, such as object pose or object size. Image recognition—classifying a detected object into different categories. Image registration—comparing and combining two different views of the same object. Decision making regarding the final decision required for the application, for example: Pass/fail on automatic inspection applications. Match/no-match in recognition applications. Flag for further human review in medical, military, security and recognition applications. Image-understanding systems (IUS) include three levels of abstraction as follows: low level includes image primitives such as edges, texture elements, or regions; intermediate level includes boundaries, surfaces and volumes; and high level includes objects, scenes, or events. Many of these requirements are entirely topics for further research. The representational requirements in the designing of IUS for these levels are: representation of prototypical concepts, concept organization, spatial knowledge, temporal knowledge, scaling, and description by comparison and differentiation. While inference refers to the process of deriving new, not explicitly represented facts from currently known facts, control refers to the process that selects which of the many inference, search, and matching techniques should be applied at a particular stage of processing. Inference and control requirements for IUS are: search and hypothesis activation, matching and hypothesis testing, generation and use of expectations, change and focus of attention, certainty and strength of belief, inference and goal satisfaction.

Machine learning (ML) module 212 can implement various optimizations and model related to AI automotive inspection and automatic ordering of automotive parts and/or services. ML a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

Machine learning module 212 can also leverage one or more LLMs. Machine learning module 212 can provide explicit and implicit technician and/or AR head view generated queries to an LLM and receive content. This content can be used to populate AR elements, technician workflows, order queries to automatically obtain vehicle parts and/or services, etc.

### Additional Example Computer Architecture and Systems

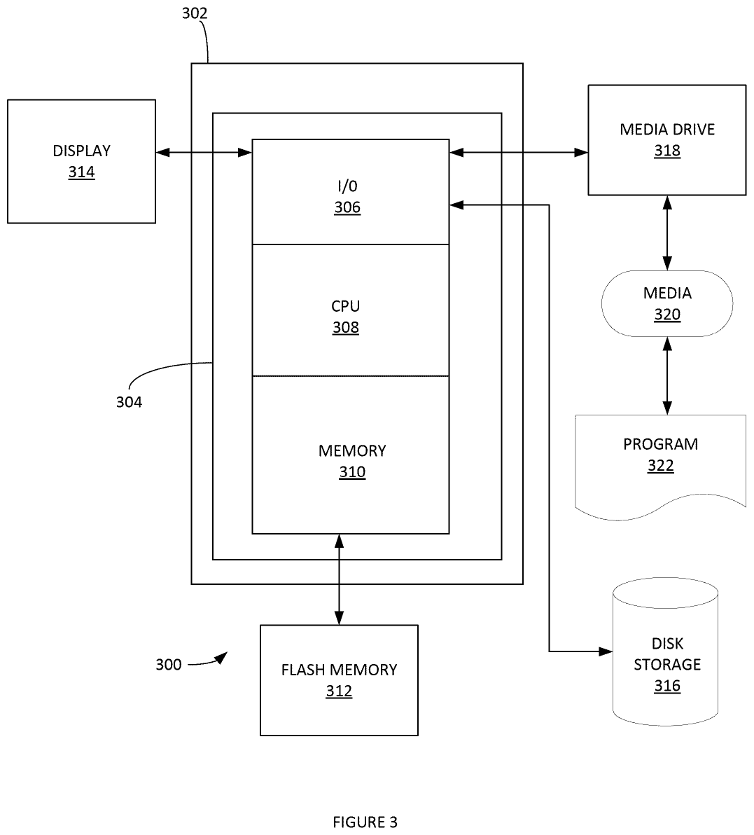

FIG. 3 depicts an exemplary computing system 300 that can be configured to perform any one of the processes provided herein. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. Computing system 300 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

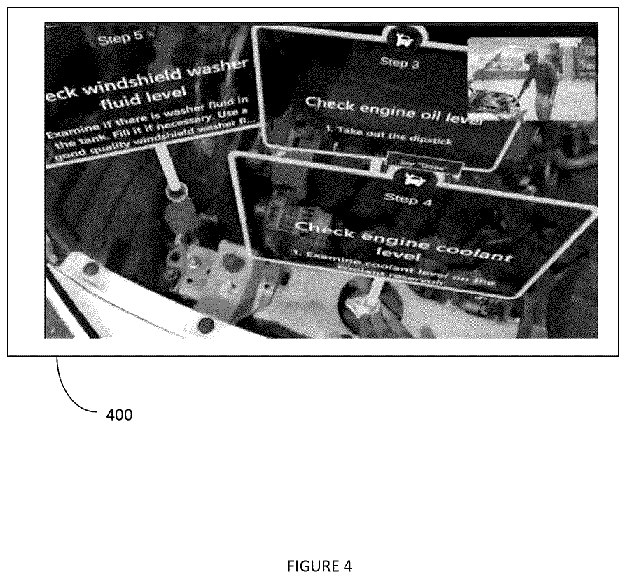

FIG. 4 illustrates an AR view 400 of what a technician would see through the AR headset during an automotive inspection workflow, according to some embodiments. View 400 displays, inter alia:

A real-world view of an automobile's engine compartment; and
Yellow-bordered AR overlays highlighting different areas to inspect;
View 400 also shows step-by-step inspection instructions within those overlays, including:
   Step 3: “Check engine oil level” with instruction “1. Take out the dipstick”;
   Step 4: “Check engine coolant level” with instruction “1. Examine coolant level on the reservoir”; and
   Step 5: “Check windshield washer fluid level” with instructions to examine if there's washer fluid in the tank and fill if necessary. These are provided by way of example.

A small video feed in the upper right corner showing what appears to be another technician or remote expert.

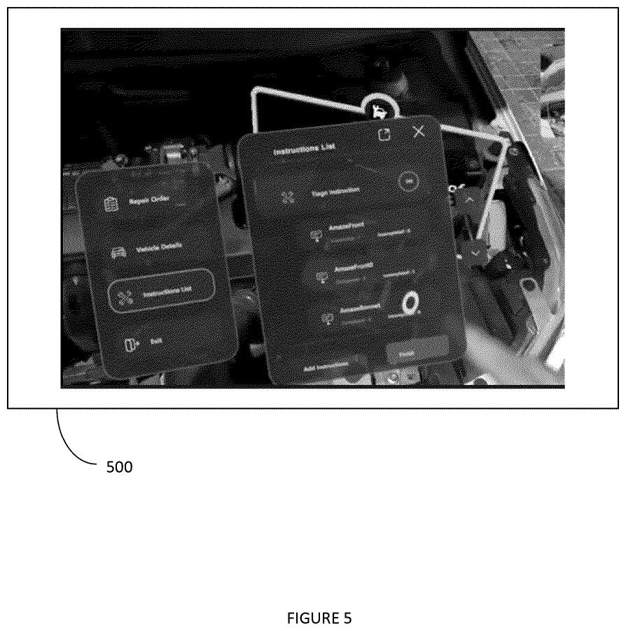

FIG. 5 shows an example view 500 of AR menu interfaces overlaid on the engine compartment, according to some embodiments. View 500 includes multiple menu panels floating in the technician's field of view. A left menu panel with options including: “Repair Order”, “Vehicle Details”, “Instructions List” (e.g. which appears selected with a green outline), “Exit”, etc. A right panel showing an expanded “Instructions List” with what appears to be: navigation controls at the top; several automotive parts listed with their status (e.g. some showing “Completed”); an “Add Instruction” option and a “Save” button at the bottom; etc.

These images (as well as those discussed infra) demonstrate the AR-assisted automotive inspection system described in the patent application, showing how technicians can view step-by-step instructions overlaid on the actual vehicle components and interact with digital menus to track their inspection progress without requiring physical input devices.

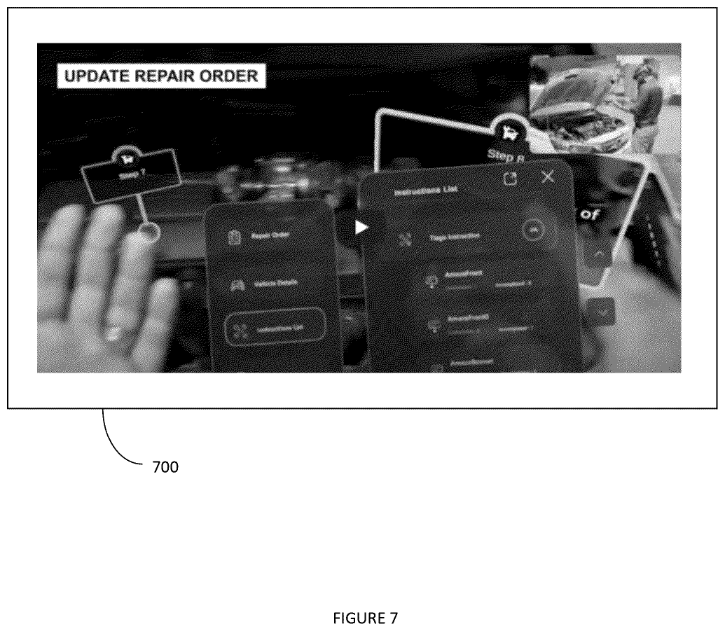

FIG. 7 shows a view 700 of the AR interface during an active inspection session with an “UPDATE REPAIR ORDER” header visible at the top, according to some embodiments. The technician's hand is visible in the frame, demonstrating the gesture-based interaction capability. The AR interface displays, inter alia: a step indicator (green “Step 1” box) showing progress in the guided workflow; a yellow-bordered AR element indicating “Step 8” elsewhere in the field of view; multiple floating menu panels including “Repair Order,” “Vehicle Details,” and “Instructions List” options. A secondary panel showing completion status of various inspection points per view 700. View 700 includes a video feed in the upper corner showing a remote technician or expert, implementing the remote expert assistance feature. This demonstrates the hands-free workflow guidance and gesture-based interaction central to the invention.

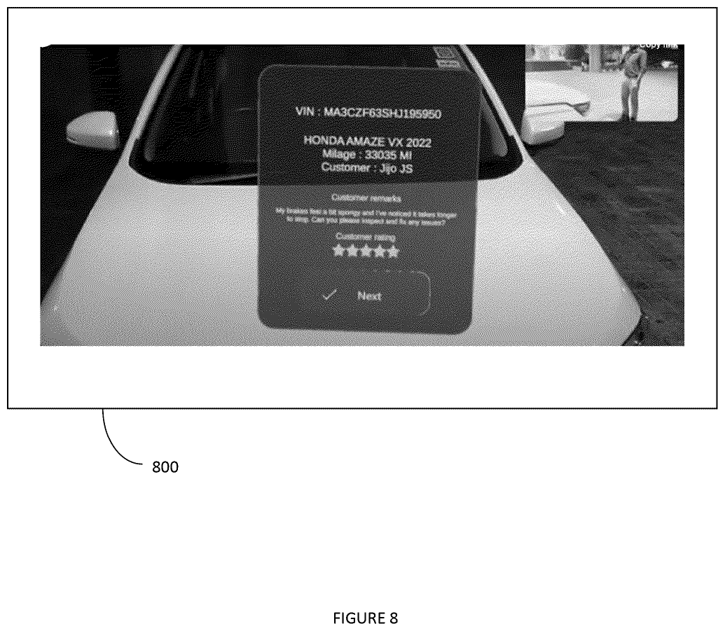

FIG. 8 illustrates a view 800 of the vehicle identification and customer information capabilities of the system. The AR overlay display, inter alia:
Automatically identified vehicle information:
   VIN: MA3CZF63SHJ195950
   Make/Model: HONDA AMAZE VX 2022
   Mileage: 33035 MI
   Customer: JIjo JS
   Customer remarks about brake issues
   Customer rating (5 stars)
   Navigation controls (“Next” button)

View 800 demonstrates the system's ability to automatically identify vehicle make and model and maintain customer information for the inspection.

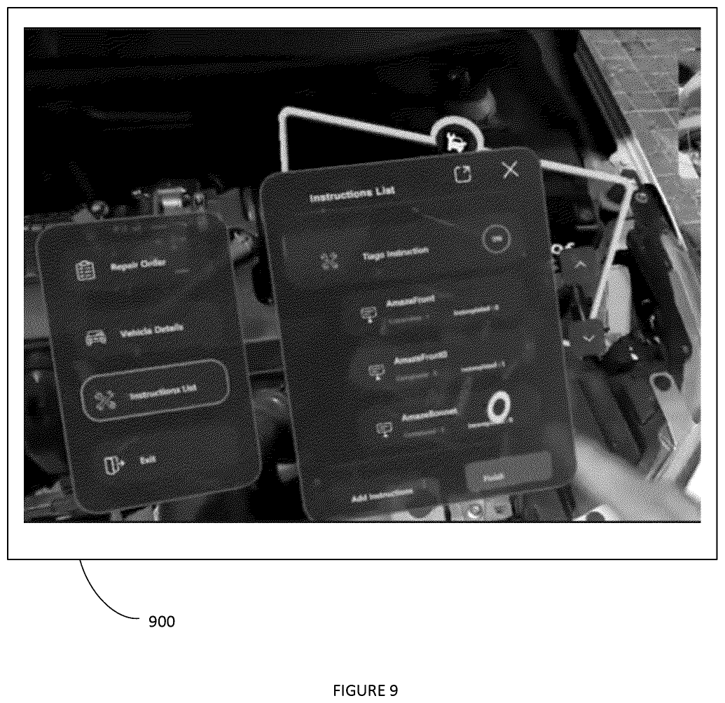

FIG. 9 illustrates a view 900 of the AR menu interface with inspection task tracking and status indicators, according to some embodiments. View 900 includes, inter alia:
A main menu panel with navigation options;
A detailed “Instructions List” panel showing completed tasks; and
Interactive elements for managing inspection tasks.

This interface enables hands-free operation during the inspection process.

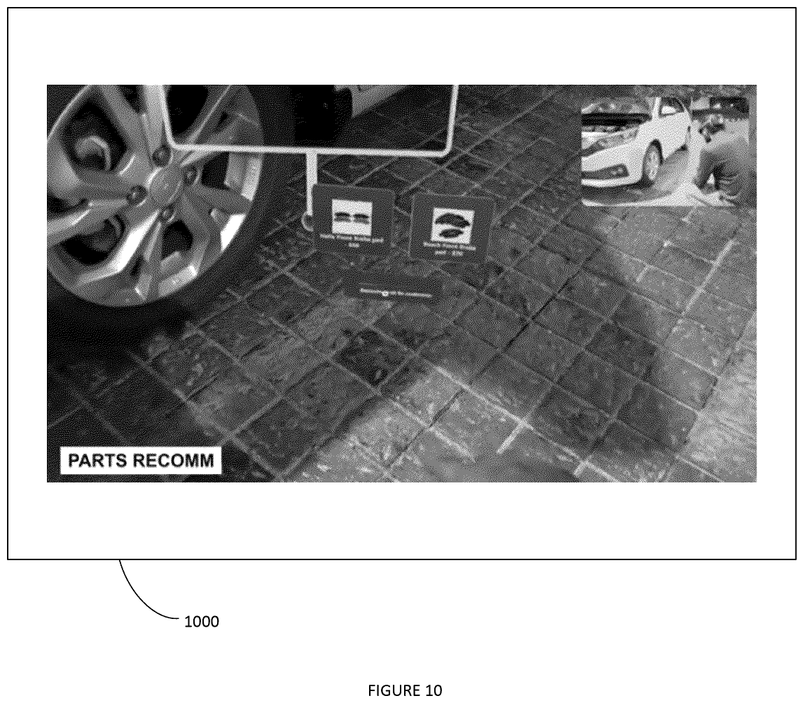

FIG. 10 provides a view 1000 that demonstrates the parts recommendation feature with a “PARTS RECOMM” label, according to some embodiments. View 1000 shows, inter alia: a view of the vehicle's wheel area; AR overlays with part options displayed as selectable icons; example pricing information (“$40-$78”) for a recommended part. A technician's finger pointing at one of the options, illustrating the gesture-based selection method. A small video feed of the remote monitoring or assistance. This directly demonstrates the automatic parts recommendation and hands-free ordering capabilities.

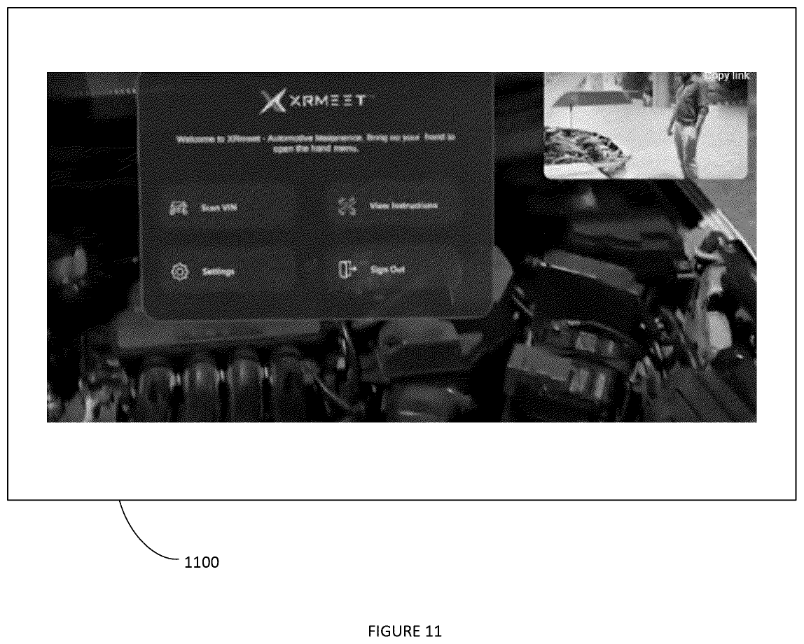

FIG. 11 illustrates a view 1100 that shows the system's main menu interface, according to some embodiments. View 1100 displays a welcome message and primary menu options: “Scan VIN”—for vehicle identification; “View Instructions”—to access inspection workflows; “Settings”—for system configuration; “Sign Out”—to exit the system; etc. View 1100 illustrates the overall user interface framework of the invention and shows how technicians would initially interact with the system at the beginning of an inspection session.

Views 700-1100 collectively demonstrate the key aspects of the invention claimed in the patent application, showing how AR technology facilitates hands-free automotive inspection and parts ordering.

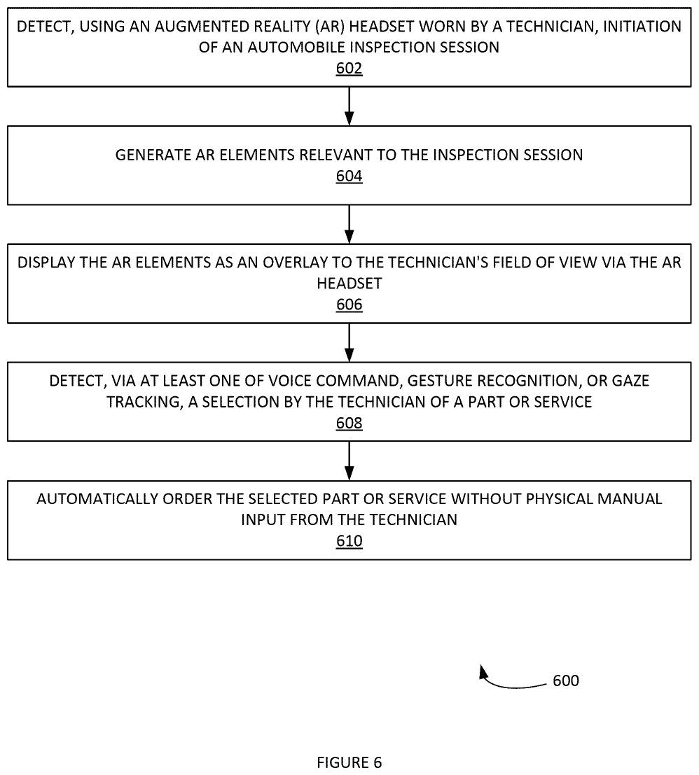

FIG. 6 illustrates an example process 600 for augmented reality assisted automotive inspection and automatic ordering of automotive parts and/or services, according to some embodiments. Process 600, in step 602, detects, using an augmented reality (AR) headset worn by a technician, initiation of an automobile inspection session. In step 604, process 600 generates AR elements relevant to the inspection session, the AR elements comprising at least one of: technician workflows, part identifications, part descriptions, and ranked ordering options for parts and services. In step 606, process 600 displays the AR elements as an overlay to the technician's field of view via the AR headset. In step 608, process 600 detects, via at least one of voice command, gesture recognition, or gaze tracking, a selection by the technician of a part or service. In step 610, process 600 automatically orders the selected part or service without physical manual input from the technician.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A method for augmented reality assisted automotive inspection and automatic ordering of automotive parts and/or services, the method comprising:
detecting, using an augmented reality (AR) headset worn by a technician, initiation of an automobile inspection session;
generating AR elements relevant to the inspection session, the AR elements comprising at least one of: technician workflows, part identifications, part descriptions, and ranked ordering options for parts and services;
displaying the AR elements as an overlay to the technician's field of view via the AR headset;
detecting, via at least one of voice command, gesture recognition, or gaze tracking, a selection by the technician of a part or service; and
automatically ordering the selected part or service without physical manual input from the technician.

2. The method of claim 1, further comprising:
capturing, via one or more cameras of the AR headset, digital images of an automobile being inspected; and
automatically identifying, using computer vision techniques, a make and model of the automobile and one or more automotive parts within the technician's field of view.

3. The method of claim 2, further comprising:
accessing an automotive part and service graph comprising information about available aftermarket and original equipment manufacturer (OEM) parts; and
ranking the available parts according to user preferences comprising at least one of: cost, quality, location of part, and time of delivery.

4. The method of claim 3, further comprising:
guiding the technician through a multi-point inspection workflow by sequentially displaying AR indicators that direct the technician to specific automobile components requiring inspection.

5. The method of claim 4, wherein the detecting of the selection by the technician comprises:
recognizing a hand gesture directed toward a specific automotive part visible in the technician's field of view; and
identifying the specific automotive part using computer vision techniques.

6. The method of claim 5, further comprising:
detecting, based on the technician's inspection activities, that expert assistance is required;
establishing a connection with a remote expert; and
displaying expert instructions within the AR overlay visible to the technician.

7. The method of claim 6, further comprising:
processing natural language voice input from the technician using a large language model (LLM) to determine part identification and ordering requirements; and
providing LLM-generated content to populate the AR elements displayed to the technician.

8. The method of claim 7, further comprising:
determining a state or condition of an identified automotive part based on computer vision analysis of images captured by the AR headset; and
automatically recommending replacement or service of the identified automotive part based on the determined state or condition.

9. The method of claim 8, further comprising:
maintaining a historical record of parts ordered for the specific automobile; and
utilizing the historical record to improve part recommendations for future inspection sessions of the same or similar automobiles.

10. The method of claim 9, wherein automatically ordering the selected part or service comprises:
generating an order request comprising part identification information;
transmitting the order request to at least one of: an automotive parts supplier, an automobile service center, and a parts warehouse; and
receiving confirmation of order fulfillment details, the confirmation being displayed to the technician via the AR headset.
